(19) United States
(12) Patent Application Publication
(10) Pub. No.: US 2005/0261455 A1
(43) Pub. Date: Nov. 24, 2005

(54) Formable styrenic resin particle, and pre-formed particle and foamed molding using the same

(75) Inventors: Takamasa Imai, Hyogo (JP); Hiroyuki Suzuki, Hyogo (JP); Hiroshi Meno, Hyogo (JP); Tatsuya Henmi, Hyogo (JP); Hidekazu Oohara, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kaneka Corporation, Kita-ku, Osaka (JP)

(21) Appl. No.: 10/522,904

(22) PCT Filed: Mar. 6, 2003
(86) PCT No.: PCT/JP03/02614

§ 371 Date: Feb. 1, 2005

(30) Foreign Application Priority Data
Aug. 9, 2002 (JP) 2002-233689

(51) Int. Cl. C08F 12/08

(52) U.S. Cl. 526/346

(57) ABSTRACT

The present invention relates to expandable styrene resin particles used for obtaining molded foams by pre-expansion and molding. To prevent the content stored in a molded foam such as food container from permeating to the container wall and through the container wall to the exterior, and to prevent mold staining, expandable styrene resin particles containing expandable styrene resin particles containing 3 to 5.5 wt % of an highly volatile blowing agent containing 15 to 60 wt % of isopentane and having a styrene monomer content of not more than 1000 ppm, wherein the expandable styrene resin particles are coated with, based on 100 parts by weight of the resin particles, 0.2 to 0.5 parts by weight of zinc stearate containing not more than 0.1 wt % of a fatty acid sodium salt are provided. In addition, to prevent permeation of the content more sufficiently, expandable styrene resin particles containing expandable styrene resin particles containing an highly volatile blowing agent and having a styrene monomer content of not more than 1000 ppm, wherein the expandable styrene resin particles are coated with 0.01 to 0.5 parts by weight of at least one kind of fatty acid amide and fatty acid bisamide, and 0.2 to 0.5 parts by weight of fatty acid metal salt based on 100 parts by weight of the resin particles are provided.

### TECHNICAL FIELD

The present invention relates to expandable styrene resin particles. More specifically, the present invention relates to expandable styrene resin particles which can noticeably prevent the content stored in a molded foam from permeating to the exterior when formed into a molded foam by pre-expansion and molding, and expandable styrene resin particles by which mold staining is extremely difficult to occur even if molded foams such as food containers are continuously molded.

### BACKGROUND ART

Generally, molded foams produced from expandable styrene resin particles are excellent in economical aspect, lightweight property, heat insulating property, strength and sanitation property, and used for food containers, cushioning materials, heat insulating materials and other purposes. As a food container, for example, the article is suitable for a container for instant noodles, fried chicken, curry and coffee.

When heated by vapor or hot air, expandable styrene resin particles turn into pre-expanded particles as a great number of cells are generated in the particles. When a mold having a desired shape is filled with the pre-expanded particles and heated by vapor, the above-described pre-expanded particles are fused with each other and a molded foam can be obtained.

The thus obtained molded foam forms a shape fit with the mold in which particles are fused with each other, but because the particles are not integrated completely, fine capillary is present on the fused particle surface. Because of this, when the molded foam is used as a container, for example, it is possible that the component of the content is permeated to the container wall and even through the container wall to the exterior, depending on the kind of the content stored. In particular, when used for a stored content rich in oil and fat, for example, curry roux having an oil and fat content of not less than 30 wt %, there is a great possibility that the component of the content is permeated to the container wall and even through the container wall to the exterior. Further, the possibility of permeation becomes noticeable when stored or transported under severe conditions such as high temperature.

As a method for preventing such permeation, U.S. Pat. No. 4,840,759 (Patent Document 1) suggests a method of using isopentane as a blowing agent. In this method, however, when the intended content is coffee, it is substantially possible to prevent permeation of coffee just for the time for pouring and drinking coffee, but preventing permeation of a content having high permeability, such as an aqueous solution containing surfactant was difficult. It has been known that when permeation of surfactant solution can be prevented, permeation of a wide range of contents including oil and fat can be substantially prevented, and therefore a permeation test using a surfactant solution has been employed as a test method for evaluating prevention of permeation. In addition, it was impossible to prevent permeation of the content substantially when used for contents rich in oil and fat such as curry roux only by using isopentane as a blowing agent as means for preventing permeation.

Japanese Patent Application Laid-Open No. 60-26042 (Patent Document 2) suggests, as means for preventing permeation of oil and fat or regular coffee, a method of coating the surface of expandable thermoplastic resin particles by zinc stearate in which not less than 90% of the particles has a particle size of not more than 10 μm and nonionic cellulose ether. However, the method of coating expandable styrene resin particles containing n-pentane as a blowing agent only with zinc stearate as described in Examples of Patent Document 2 was not substantially capable of preventing permeation of surfactant solution, in particular, practically preventing permeation of curry roux and the like which contain a large amount of oil and fat. The ability to prevent permeation of curry roux is improved to a certain degree by using nonionic cellulose ether together, but fusibility in the molding process can be affected and it cannot be said that the practical level has been met.

Further, Japanese Patent Application Laid-Open No. 11-322995 (Patent Document 3) suggests a method of coating the surface of expandable styrene resin particles with a fluorine polymer as means for preventing permeation of a content having high permeability including surfactant solution. By using this method, it is possible to prevent permeation of surfactant solution, but the cost due to the very expensive fluorine polymers is disadvantage, and because the fusion of pre-expanded particles in the molding process tends to be inhibited, there has been a problem that the mechanical strength of the obtained molded article may be decreased unless the molding conditions are carefully controlled. In addition, some of the fluorine compounds are reported to be cumulative in the human body, and therefore for food contact use, a safer solution without using a fluorine compound has been desired.

In addition, Japanese Patent Application Laid-Open No. 55-127441 (Patent Document 4), Japanese Patent Application Laid-Open No. 61-157538 (Patent Document 5) and Japanese Patent Application Laid-Open No. 56-106930 (Patent Document 6) suggest a method of coating the surface of expandable styrene resin particles with fatty acid amide and/or fatty acid bisamide as a anti-blocking agent in the pre-expansion process. However, the prevention of permeation to the exterior of the content stored in the container is not described. Further, in Patent Document 4, in addition to higher fatty acid bisamide, zinc stearate and higher fatty acid metal salt other than zinc stearate, higher fatty acid is an essential component as the forth component. Patent Documents 5 and 6 are also different from the present invention in that a second component other than higher fatty acid amide, which is not used in the present invention, is an essential component.

Japanese Patent Application Laid-Open No. 5-209081 (Patent Document 7) suggests a method of coating the surface of expandable styrene resin particles with fatty acid bisamide instead of zinc stearate which has been conventionally used as a component for preventing blocking of pre-expanded particles and damage on the particle surface when sieving the particles, but the prevention of permeation to the exterior of the content stored in the container is not described. In fact, it was difficult to prevent the content stored in the container from permeating to the exterior only by fatty acid bisamide.

On the other hand, when food containers such as cups for instant noodles are continuously molded using expandable styrene resin particles, the surface of the mold is stained black, causing insufficient fusion due to poor heat transmission and demolding trouble in some cases. However, effective means for preventing such mold staining has not been found.
Patent Document 1: U.S. Pat. No. 4,840,759
Patent Document 2: Japanese Patent Application Laid-Open No. 60-26042
Patent Document 3: Japanese Patent Application Laid-Open No. 11-322995
Patent Document 4: Japanese Patent Application Laid-Open No. 55-127441
Patent Document 5: Japanese Patent Application Laid-Open No. 61-157538
Patent Document 6: Japanese Patent Application Laid-Open No. 56-106930
Patent Document 7: Japanese Patent Application Laid-Open No. 5-209081

### DISCLOSURE OF THE INVENTION

In view of the above problems of the conventional arts, the present invention provides expandable styrene resin particles which can noticeably prevent the content stored in a molded foam from permeating to the exterior when formed into a molded foam by pre-expansion and molding, and expandable styrene resin particles by which mold staining is extremely difficult to occur even if molded foams such as food containers are continuously molded.

That is, the present invention provides the following expandable styrene resin particles, pre-expanded particles and molded foams.

(1) Expandable styrene resin particles comprising expandable styrene resin particles containing 3 to 5.5 wt % of a highly volatile blowing agent containing 15 to 60 wt % of isopentane and having a styrene monomer content of not more than 1000 ppm, wherein the expandable styrene resin particles are coated with, based on 100 parts by weight of the resin particles, 0.2 to 0.5 parts by weight of zinc stearate containing not more than 0.1 wt % of a fatty acid sodium salt.

(2) The expandable styrene resin particles according to the above (1), wherein the highly volatile blowing agent contains 30 to 60 wt % of isopentane.

(3) The expandable styrene resin particles according to the above (1), wherein the highly volatile blowing agent comprises 15 to 60 wt % of isopentane, 85 to 40 wt % of n-pentane and 0 to 20 wt % of butane and/or propane.

(4) The expandable styrene resin particles according any one of the above (1) to (3), wherein zinc stearate is produced by a direct method.

(5) Pre-expanded particles obtained by subjecting the expandable styrene resin particles according to any one of the above (1) to (4) to pre-expansion.

(6) A molded foam obtained by subjecting the pre-expanded particles according to the above (5) to expansion molding.

(7) The molded foam according to the above (6), wherein the molded foam is a food container.

(8) The molded foam according to the above (7), wherein the molded foam is a food container in accordance with the standard for hot water containers prescribed by the Food Sanitation Law in Japan.

(9) Expandable styrene resin particles comprising expandable styrene resin particles containing a highly volatile blowing agent and having a styrene monomer content of not more than 1000 ppm, wherein the expandable styrene resin particles are coated with 0.01 to 0.5 parts by weight of at least one selected from the group consisting of fatty acid amides represented by the following formula (1) and fatty acid bisamides represented by the following formula (2), and 0.2 to 0.5 parts by weight of fatty acid metal salt based on 100 parts by weight of the resin particles: 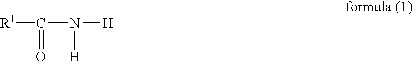
wherein R¹ is a saturated or unsaturated aliphatic hydrocarbon group; and 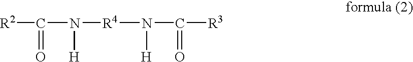
wherein R² and R³ are a saturated or unsaturated aliphatic hydrocarbon group and R⁴ is a divalent aliphatic hydrocarbon group or aromatic hydrocarbon group, provided that R² and R³ may be the same or different.

(10) The expandable styrene resin particles according to the above (9), wherein the aliphatic hydrocarbon groups R¹, R² and R³ in the formulas (1) and (2) have 7 to 23 carbon atoms.

(11) The expandable styrene resin particles according to the above (10), wherein the aliphatic hydrocarbon groups R¹, R² and R³ in the formulas (1) and (2) have 17 carbon atoms.

(12) The expandable styrene resin particles according to any one of the above (9) to (11), wherein the hydrocarbon group R⁴ in the formula (2) has 1 to 8 carbon atoms.

(13) The expandable styrene resin particles according to any one of the above (9) to (12), wherein at least one kind of fatty acid amide represented by the formula (1) and fatty acid bisamide represented by the following formula (2) is stearic acid amide and/or ethylene bis stearic acid amide.

(14) The expandable styrene resin particles according to any one of the above (9) to (13), wherein at least one kind of fatty acid amide represented by the formula (1) and fatty acid bisamide represented by the following formula (2) is ethylene bis stearic acid amide.

(15) The expandable styrene resin particles according to any one of the above (9) to (14), wherein the fatty acid metal salt is produced by a direct method.

(16) The expandable styrene resin particles according to any one of the above (9) to (15), wherein the fatty acid metal salt is zinc stearate.

(17) The expandable styrene resin particles according to any one of the above (9) to (16), wherein the content of the highly volatile blowing agent is 3 to 6 wt %.

(18) The expandable styrene resin particles according to any one of the above (9) to (17), wherein the highly volatile blowing agent contains 15 to 60 wt % of isopentane.

(19) The expandable styrene resin particles according to any one of the above (9) to (18), wherein the highly volatile blowing agent comprises 15 to 60 wt % of isopentane, 85 to 40 wt % of n-pentane and 0 to 20 wt % of butane and/or propane.

(20) The expandable styrene resin particles according to any one of the above (9) to (19), which have a particle size of 0.2 to 0.6 mm.

(21) Pre-expanded particles obtained by subjecting the expandable styrene resin particles according to any one of the above (9) to (20) to pre-expansion.

(22) A molded foam obtained by subjecting the pre-expanded particles according to the above (21) to expansion molding.

(23) The molded foam according to the above (22), wherein the molded foam is a food container.

(24) The molded foam according to the above (23), wherein the molded foam is a food container in accordance with the standard for hot water containers prescribed by the Food Sanitation Law in Japan.

In the following, the present invention is described in more detail.

According to one embodiment of the present invention, expandable styrene resin particles comprising expandable styrene resin particles containing 3 to 5.5 wt % of a highly volatile blowing agent containing 15 to 60 wt % of isopentane and having a styrene monomer content of not more than 1000 ppm, wherein the expandable styrene resin particles are coated with, based on 100 parts by weight of the resin particles, 0.2 to 0.5 parts by weight of zinc stearate containing not more than 0.1 wt % of a fatty acid sodium salt are provided (hereinafter this invention is referred to as the first invention).

As a result of intensive studies in view of the actual conditions of the conventional arts, the present inventors have found that a molded foam obtained by subjecting to pre-expansion and molding expandable styrene resin particles produced by adding a highly volatile blowing agent containing 15 to 60 wt % of isopentane to styrene resin particles having a styrene monomer content of not more than 1000 ppm, which are used for purposes such as a food container, and further coating the particle surface with 0.2 to 0.5 parts by weight of zinc stearate based on 100 parts by weight of the resin particles, is excellent in the ability to prevent permeation of surfactant solution substantially, that is, the article can prevent a wide range of contents including oil and fat from permeating to the exterior, and therefore exhibits extremely superior properties as a container for oil and fat containing contents, and as food containers such as a hot water container.

In addition, while the amount of zinc stearate for coating expandable styrene resin particles to prevent permeation is usually larger than the amount for coating to prevent blocking, the present inventors have found that expansion molding of expandable styrene resin particles coated with such a large amount of zinc stearate tends to cause greater mold staining, and conducted intensive studies to solve the problem of the mold staining. As a result, it has been surprisingly found that by using, as zinc stearate used for coating, zinc stearate containing not more than 0.1 wt % of a fatty acid sodium salt which is an impurity, the mold surface would not be stained black even if molded foams such as food containers are continuously molded.

The styrene resin particles in the first invention are particles of generally known styrene resin of which the main component is styrene, and may be a styrene homopolymer, or a copolymer of an individual monomer such as a styrene derivative such as α-methyl styrene, p-methyl styrene, t-butyl styrene and chlorostyrene, an ester of acrylic acid or methacrylic acid such as methyl acrylate, butyl acrylate, methyl methacrylate, ethyl methacrylate and cetyl methacrylate, acrylonitrile, dimethyl fumarate or ethyl fumarate with styrene. In addition, difunctional monomers such as divinyl benzene and alkylene glycol dimethacrylate may also be used together. In the present invention, styrene and styrene derivatives are referred to as a styrene monomer. As a styrene resin, one having a weight average molecular weight of 150,000 to 400,000, preferably 250,000 to 350,000 which is generally usable as expanded polystyrene may be used.

As the styrene resin particles in the first invention, those produced by a usual suspension polymerization method or so-called suspension seed polymerization method in which polymerization is conducted while adding styrene monomers such as styrene to styrene resin seed particles dispersed in an aqueous suspension and impregnating thereby the monomers into the seed particles may be used. The resin seed particles to be used for suspension seed polymerization can be obtained by (1) a usual suspension polymerization method or (2) a method comprising dispersing polymerizable monomers in an aqueous medium in the form of a number of droplets by passing through a nozzle under regular vibration and polymerizing without causing bonding or additional dispersion. By adding the highly volatile blowing agent described later in the polymerization step of styrene resin particles or after the completion of the polymerization step, expandable styrene resin particles are obtained.

The amount of the styrene monomer contained in the expandable styrene resin particles in the first invention (herein meaning expandable styrene resin particles before coating treatment with zinc stearate described later) needs to be kept to not more than 1000 ppm (based on weight). This is because when pre-expansion and molding expandable styrene resin particles so as to be used, for example, for a container of instant noodles, the amount of the styrene monomer remaining in the container is defined to be not more than 1000 ppm according to the standard for hot water containers prescribed by the Food Sanitation Law in Japan. The amount of styrene monomer in the expandable styrene resin particles is preferably not more than 500 ppm, more preferably not more than 200 ppm. The amount of not more than 500 ppm is preferable because odor is reduced. As a method for decreasing the amount of remaining styrene monomer contained in the expandable styrene resin particles to not more than 1000 ppm, a method comprising post-polymerization using not less than 0.05 part by weight of a high temperature decomposable polymerization initiator such as 1,1-bis(t-butylperoxy)-3,3,5-trimethylcyclohexane based on 100 parts by weight of the polymerizable monomers at a high temperature of not less than 110° C. is employed. According to the standard for hot water containers prescribed by the Food Sanitation Law in Japan, in addition to the specified remaining amount of styrene monomer of not more than 1000 ppm, the remaining amount of ethyl benzene is defined to be not more than 1000 ppm, and the total remaining amount of styrene, toluene, ethyl benzene, isopropyl benzene and n-propyl benzene is defined to be not more than 2000 ppm.

In addition, the particle size of the expandable styrene resin particles in the first invention (herein meaning expandable styrene resin particles before coating treatment with zinc stearate described later) is preferably within the range of 0.2 to 0.6 mm when used for food containers. When the particle size is smaller than 0.2 mm, the emission rate of the highly volatile blowing agent is too fast and the bead life is shortened, and when the particle size is grater than 0.6 mm, filling property to the mold becomes poor because a general food container has a thin wall thickness of about 2 mm. As a method for obtaining particles having a particle size in the range of 0.2 to 0.6 mm, particles obtained by a usual suspension polymerization method may be classified or the above-mentioned suspension seed polymerization method may be employed. The suspension seed polymerization method is preferable because a higher yield can be achieved.

In the first invention, the highly volatile blowing agent contained in the expandable styrene resin particles (herein meaning expandable styrene resin particles before coating treatment) comprises 15 to 60 wt %, preferably 30 to 60 wt %, more preferably 35 to 55 wt %, most preferably 35 to 50 wt % of isopentane. The content of the highly volatile blowing agent other than isopentane is 85 to 40 wt %, preferably 70 to 40 wt %, more preferably 65 to 45 wt %, and most preferably 65 to 50 wt %. When the content of isopentane is less than the above-mentioned range, there is a tendency that permeation of a content having high permeability such as a surfactant solution cannot be suppressed sufficiently. On the other hand, when the content exceeds the above-mentioned range, gaps between particles in the molded foam tend to increase, damaging the superiority in surface appearance.

Examples of the highly volatile blowing agent other than isopentane include aliphatic hydrocarbons such as propane, n-butane, isobutane, n-pentane, neopentane, n-hexane and alicyclic hydrocarbons such as cyclobutane, cyclopentane and cyclohexane.

In the first invention, it is preferable to use isopentane and n-pentane together as the highly volatile blowing agent and where necessary, n-butane, isobutane and propane may be used together. The composition of the highly volatile blowing agents is, based on the total amount of the highly volatile blowing agents, preferably 15 to 60 wt % of isopentane, 85 to 40 wt % of n-pentane and 0 to 20 wt % of n-butane and/or isobutane (hereinafter sometimes abbreviated simply as butane) and/or propane, more preferably 30 to 60 wt % of isopentane, 70 to 40 wt % of n-pentane and 0 to 20 wt % of butane and/or propane, particularly preferably 35 to 55 wt % of isopentane, 65 to 45 wt % of n-pentane and 0 to 20 wt % of butane and/or propane, and most preferably 35 to 50 wt % of isopentane, 65 to 50 wt % of n-pentane and 0 to 20 wt % of butane and/or propane. When the content of n-pentane is less than the above-mentioned range, gaps between particles in the molded foam tend to increase, damaging the superiority in surface appearance. On the other hand, when the content exceeds the above-mentioned range, there is a tendency that permeation of a content having high permeability such as a surfactant solution cannot be suppressed sufficiently. When butane and/or propane are/is used together, the pre-expanded particles obtained by pre-expansion tend to have a smaller cell diameter, which improves the strength of the molded foam, and therefore they are used together where necessary. In view of this, in the case of attaching particular importance to the strength of the molded foam, preferred is a composition of the highly volatile blowing agent of 15 to 60 wt % of isopentane, 83 to 38 wt % of n-pentane and 2 to 15 wt % of butane and/or propane based on the total amount of the highly volatile blowing agents.

The content of the highly volatile blowing agent in the expandable styrene resin particles (herein meaning expandable styrene resin particles before coating treatment) in the first invention is 3 to 5.5 wt %. The content is preferably 3.3 to 5.0 wt %, particularly preferably 3.5 to 4.5 wt %. When the content of the highly volatile blowing agent is smaller than the above-mentioned range, there is a tendency that the fusion ratio in the molding process is decreased and the strength of the molded foam is decreased. On the other hand, when the content exceeds the above-mentioned range, gaps between particles in the molded foam tend to increase, damaging the superiority in surface appearance. These blowing agents may be added in the polymerization step of the styrene resin particles or after the completion of the polymerization step.

In the first invention, to shorten the pre-expansion time of the expandable styrene resin particles, liquid paraffin may be used as a plasticizer. In the case of use as a food container, in particular, liquid paraffin can be used securely because it is registered as a food additive. The content of the liquid paraffin in the expandable styrene resin particles is preferably 0.05 to 1 part by weight based on 100 parts by weight of the expandable styrene resin particles (herein meaning expandable styrene resin particles before coating treatment). When the content is less than 0.05 part by weight, the shortening of pre-expansion time is hardly seen and when the content is more than 1 part by weight, the surface of the molded foam obtained by molding becomes sticky, which is not preferable.

It is known in the conventional arts that zinc stearate is used as an anti-blocking agent in the pre-expansion process, but the amount to be used has been less than 0.2 part by weight at most based on 100 parts by weight of expandable styrene resin particles. However, in the first invention, for preventing permeation of content in a food container in addition to preventing blocking in the pre-expansion process and facilitating release from the mold, it is required to use zinc stearate in the range of 0.2 to 0.5 parts by weight based on 100 parts by weight of the expandable styrene resin particles (herein meaning expandable styrene resin particles before coating treatment). When the amount to be used of zinc stearate is less than 0.2 part by weight, there is a tendency that permeation of surfactant solution cannot be suppressed sufficiently. When the amount is more than 0.5 parts by weight, there is a tendency that the fusion in the molding process becomes insufficient and the strength of the molded foam is decreased. In view of this, the amount to be used of zinc stearate is preferably 0.25 to 0.45 part by weight, more preferably 0.3 to 0.4 part by weight based on 100 parts by weight of expandable styrene resin particles.

Generally, fatty acids constituting commercially available zinc stearate are a mixture of stearic acid which is the main component with palmitic acid, myristic acid, lauric acid, arachidic acid and behenic acid. Such commercially available product can also be used as zinc stearate in the first invention.

However, the content of a fatty acid sodium salt contained in zinc stearate used in the present invention is not more than 0.1 wt %, preferably not more than 0.08 wt %, more preferably not more than 0.05 wt %. When the content of the a fatty acid sodium salt exceeds the above-mentioned range, the surface of the mold is stained black when molded foams such as food containers are continuously produced, causing insufficient fusion due to poor heat transmission and demolding trouble.

In the present invention, zinc stearate is used in a larger amount in conventional arts and influence by a fatty acid sodium salt contained in zinc stearate is great, and therefore, controlling the content of a fatty acid sodium salt leads to quite favorable results.

Here, examples of the typical method of producing metal soap such as zinc stearate include a double decomposition method and a direct method. Of these, in the double decomposition method, a fatty acid sodium salt which causes the mold staining is produced as an intermediate product as shown in the reaction formulas (3) and (4), and part of unreacted a fatty acid sodium salt remains as an impurity in zinc stearate which is the final product.

(Example of Reaction in Double Decomposition Method)
CₙH₂ₙ₊₁COOH+NaOH→CₙH₂ₙ₊₁COONa+H₂O (3)
2CₙH₂ₙ₊₁COONa+ZnCl₂→(CnH₂ₙ₊₁COO)₂Zn↓+2NaCl (4)

On the other hand, in the direct method, fatty acid (stearic acid) and metal oxide (ZnO) or metal hydroxide (Zn(OH)₂) are directly reacted and therefore a fatty acid sodium salt is not generated in the production steps. Accordingly, to prevent mold staining, it is particularly preferable to use zinc stearate containing no a fatty acid sodium salt prepared by the direct method rather than zinc stearate prepared by the double decomposition method, which is likely to contain a fatty acid sodium salt. Even in the case of zinc stearate prepared by the double decomposition method, the mold staining can be prevented by setting the content of a fatty acid sodium salt to not more than the above-mentioned range. However, in order to prevent the mold staining and achieve longer-term continuous production, it is desirable to conduct purification to further decrease the a fatty acid sodium salt content, so as to bring it closer to zinc stearate prepared by the direct method of which the a fatty acid sodium salt content is zero.

The particle size of zinc stearate to be used in the first invention is not particularly limited. Generally, from the viewpoint of ease of coating treatment, zinc stearate having an average particle size of 8 to 15 μm, preferably 10 to 13 μm is used. Needless to say, one having a larger or smaller particle size can exhibit the desired effect.

Examples of the method of coating or attaching zinc stearate on the surface of the expandable styrene resin particles include a method of mixing both in a mixer such as a Henschel mixer for a pre-determined time. In the first invention, coating refers to the state where zinc stearate is present on the surface of the expandable styrene resin particles in some way by coating or attaching.

In the first invention, other additives which has an effect of facilitating fusion can also be used in the molding process and examples thereof include higher fatty acid amide such as stearic acid amide and higher fatty acid glyceride such as hydrogenated castor oil and hydrogenated soybean oil.

In addition, one or more kinds of glycerin, polyethylene glycol, polypropylene glycol and fatty acid monoglyceride which are generally used as an antistatic agent may also be used together. Of these, it is preferable to use polyethylene glycol.

As the pre-expansion method of expandable styrene resin particles in the first present invention, a conventionally known method can be employed. For example, by heating at about 80 to 110° C. using vapor in a rotational stirring pre-expander, pre-expanded particles having a bulk density of about 90 to 120 g/L can be obtained. In addition, a molded foam can be formed by filling the mold having a desired shape with the obtained pre-expanded particles and heating at about 130 to 145° C. using vapor.

The molded foam molded from the expandable styrene resin particles of the first invention is suitably used for food containers for instant noodles, curry roux, instant noodles with curry roux, stew, mayonnaise, margarine, doughnuts, hamburgers, fried chicken and coffee.

In another embodiment of the present invention, expandable styrene resin particles comprising expandable styrene resin particles containing a highly volatile blowing agent and having a styrene monomer content of not more than 1000 ppm, wherein the expandable styrene resin particles are coated with 0.01 to 0.5 parts by weight of at least one selected from the group consisting of fatty acid amides represented by the following formula (1) and fatty acid bisamides represented by the following formula (2), and 0.2 to 0.5 parts by weight of fatty acid metal salt based on 100 parts by weight of the resin particles are provided (hereinafter this invention is referred to as the second invention). 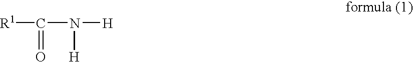
wherein R¹ is a saturated or unsaturated aliphatic hydrocarbon group. 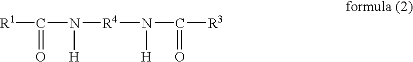
wherein R² and R³ are a saturated or unsaturated aliphatic hydrocarbon group, R⁴ is a divalent aliphatic hydrocarbon group or aromatic hydrocarbon group, provided that R² and R³ may be the same or different.

As a result of further intensive studies based on the first invention, the present inventors have found a completely unexpected result that a molded foam such as a food container obtained by pre-expansion and then molding expandable styrene resin particles coated with a combination of a fatty acid metal salt represented by zinc stearate and a fatty acid amide and/or fatty acid bisamide can prevent not only permeation of surfactant solution but also permeation of contents substantially even if the article is used as a container for a content having a greater amount of oil and fat and a higher permeability, and stored and transported under severe conditions such as high temperature.

As the styrene resin particles in the second invention, styrene resin particles similar to those used in the first invention can be used. The same definitions as in the first invention apply to the weight average molecular weight (preferably 150,000 to 400,000, more preferably 250,000 to 350,000) and the polymerization methods (suspension polymerization, suspension seed polymerization method). The same definitions as in the first invention apply to the remaining amount of styrene monomers in expandable styrene resin particles (not more than 1000 ppm, preferably not more than 500 ppm, more preferably not more than 200 ppm) and the particle size (preferably 0.2 to 0.6 mm).

Examples of the highly volatile blowing agent used in the second invention include aliphatic hydrocarbons such as propane, n-butane, isobutane, n-pentane, isopentane, neopentane and n-hexane and alicyclic hydrocarbons such as cyclobutane, cyclopentane and cyclohexane. These can be used alone or in combination of two or more kinds.

The content of the highly volatile blowing agent in the expandable styrene resin particles in the second invention (herein meaning expandable styrene resin particles before coating treatment with fatty acid amide and/or fatty acid bisamide and fatty acid metal salt described later) is preferably 3 to 6 wt %, more preferably 3 to 5.5 wt %, particularly preferably 3.5 to 5.5 wt %, most preferably 4.0 to 5.0 wt %. When the content of the highly volatile blowing agent is smaller than the above-mentioned range, there is a tendency that the fusibility in the molding process is decreased and the strength of the molded foam is decreased. On the other hand, when the content is greater than the above-mentioned range, gaps between particles in the molded foam tend to increase, damaging the superiority in surface appearance. These blowing agents may be added in the polymerization step of the expandable styrene resin particles or after the completion of the polymerization step.

In the second invention, the highly volatile blowing agent contained in the expandable styrene resin particles (herein meaning expandable styrene resin particles before coating treatment) comprises preferably 15 to 60 wt %, more preferably 30 to 60 wt %, particularly preferably 35 to 55 wt %, most preferably 35 to 50 wt % of isopentane. In that case, the content of the highly volatile blowing agent other than isopentane is preferably 85 to 40 wt %, more preferably 70 to 40 wt %, particularly preferably 65 to 45 wt %, and most preferably 65 to 50 wt %. When the content of isopentane is less than the above-mentioned range, there is a tendency that permeation of a content having high permeability such as a surfactant solution cannot be suppressed sufficiently. On the other hand, when the content exceeds the above-mentioned range, gaps between particles in the molded foam tend to increase, damaging the superiority in surface appearance.

In the second invention, it is preferable to use isopentane and n-pentane together as the highly volatile blowing agent and where necessary, n-butane, isobutane and propane may be used together. The composition of the highly volatile blowing agents is, based on the total amount of the highly volatile blowing agents, preferably 15 to 60 wt % of isopentane, 85 to 40 wt % of n-pentane and 0 to 20 wt % of n-butane and/or isobutane (hereinafter sometimes abbreviated simply as butane) and/or propane, more preferably 30 to 60 wt % of isopentane, 70 to 40 wt % of n-pentane and 0 to 20 wt % of butane and/or propane, particularly preferably 35 to 55 wt % of isopentane, 65 to 45 wt % of n-pentane and 0 to 20 wt % of butane and/or propane, and most preferably 35 to 50 wt % of isopentane, 65 to 50 wt % of n-pentane and 0 to 20 wt % of butane and/or propane. When the content of n-pentane is below the above-mentioned range, gaps between particles in the molded foam tend to increase, damaging the superiority in surface appearance. On the other hand, when the content exceeds the above-mentioned range, there is a tendency that permeation of a content having high permeability such as a surfactant solution cannot be suppressed sufficiently. When butane and/or propane are/is used together, the pre-expanded particles obtained by pre-expansion tend to have a smaller cell diameter, which improves the strength of the molded foam, and therefore they are used together where necessary. In view of this, in the case of attaching particular importance to the strength of the molded foam, preferred is a composition of the highly volatile blowing agent of 15 to 60 wt % of isopentane, 83 to 38 wt % of n-pentane and 2 to 15 wt % of butane and/or propane based on the total amount of the highly volatile blowing agents.

In the second invention, fatty acid amide represented by the formula (1) and/or fatty acid bisamide represented by the formula (2) are/is used. 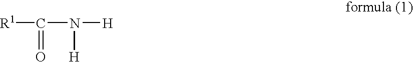
wherein R¹ is a saturated or unsaturated aliphatic hydrocarbon group. 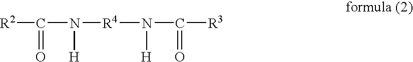
wherein R² and R³ are a saturated or unsaturated aliphatic hydrocarbon group and R⁴ is a divalent aliphatic hydrocarbon group or aromatic hydrocarbon group, provided that R² and R³ may be the same or different.

In the formulas (1) and (2), as the saturated or unsaturated aliphatic hydrocarbon group represented by R¹, R² and R³, one having 7 to 23 carbon atoms is preferable, one having 15 to 21 carbon atoms is more preferable and one having 17 carbon atoms is particularly preferable. The saturated or unsaturated aliphatic hydrocarbon group represented by R¹, R² and R³ may have a substituent such as a hydroxyl group. Specific examples of fatty acid which provides R¹—CO—group, R²—CO— group or R³—CO— group include caprylic acid, capric acid, lauric acid, myristic acid, palmitic acid, stearic acid, 12-hydroxystearic acid, arachidic acid, behenic acid, lignoceric acid, obtusilic acid, caproleic acid, linderic acid, tsuzuic acid, physeteric acid, zoomaric acid, oleic acid, petroselinic acid, gadoleic acid, erucic acid, selacholeic acid, linoleic acid, linolenic acid, and recinoleic acid.

In the formula (2), as the divalent aliphatic hydrocarbon group represented by R⁴, one having 1 to 8 carbon atoms is preferable, and as the divalent aromatic hydrocarbon group, one having 6 to 8 carbon atoms is preferable. Specific examples of the divalent aliphatic hydrocarbon groups represented by R⁴ include methylene, ethylene, trimethylene, propylene, tetramethylene, butylene, pentamethylene, hexamethylene, heptamethylene and octamethylene. Specific examples of the divalent aromatic hydrocarbon group represented by R⁴ include phenylene, tolylene and xylylene.

Examples of the fatty acid amide represented by the formula (1) include caprylic acid amide, capric acid amide, lauric acid amide, myristic acid amide, palmitic acid amide, stearic acid amide, arachidic acid amide, behenic acid amide, lignoceric acid amide, 12-hydroxystearic acid amide, oleic acid amide, erucic acid amide and recinoleic acid amide.

The fatty acid bisamide represented by the formula (2) means diamide of diamine and fatty acid, and the two fatty acids forming two amide bonds may be the same or different. That is, aliphatic hydrocarbon groups R² and R³ in the formula (2) may be the same or different.

Generally, in commercially available fatty acid bisamide, the number of carbon atoms of the used fatty acid is not fixed but distributed. Accordingly, it is substantially a mixture of bisamide in which R² and R³ are identical and diamide in which R² and R³ are different. Examples of the fatty acid bisamide which can be used in the second invention include ethylene bis caprylic acid amide, ethylene bis capric acid amide, ethylene bis lauric acid amide, ethylene bis stearic acid amide, ethylene bis isostearic acid amide, ethylene bis hydroxystearic acid amide, ethylene bis behenic acid amide, hexamethylene bis stearic acid amide, hexamethylene bis hydroxystearic acid amide, ethylene bis oleic acid amide, ethylene bis erucic acid amide, hexamethylene bis oleic acid amide, methylene bis lauric acid amide, methylene bis stearic acid amide, methylene bis hydroxystearic acid amide, methylene bis oleic acid amide and xylylene bis stearic acid amide. In the second invention, one or a mixture of at least two kinds selected from these bisamides can be used.

In the second invention, it is preferable to use fatty acid bisamide rather than fatty acid amide. In addition, of the fatty acid amides and fatty acid bisamides described above, it is preferable to use stearic acid amide and/or ethylene bis stearic acid amide, and of these, it is most preferable to use ethylene bis stearic acid amide alone.

The amount to be used of fatty acid amide and/or fatty acid bisamide in the second invention is 0.01 to 0.5 parts by weight, preferably 0.05 to 0.3 part by weight, more preferably 0.1 to 0.25 part by weight based on 100 parts by weight of the expandable styrene resin particles (herein meaning expandable styrene resin particles before coating treatment). When the amount to be used of fatty acid amide and/or fatty acid bisamide is smaller than the above-mentioned range, the effect of preventing permeation of the contents in the food container including oil and fat tends to decrease. On the other hand, when the amount exceeds the above-mentioned range, there is a tendency that the fusion of particles becomes poor and the molding cycle becomes long.

In the second invention, fatty acid metal salt is used together with fatty acid amide and/or fatty acid bisamide. By using fatty acid metal salt together with fatty acid amide and/or fatty acid bisamide, permeation of contents having a large amount of oil and fat can be prevented effectively.

Examples of the fatty acid metal salt include long-chain fatty acid metal salts such as zinc stearate, calcium stearate, magnesium stearate, aluminum stearate, zinc laurate and calcium laurate. Of these, it is particularly preferable to use zinc stearate. Generally, fatty acids constituting commercially available zinc stearate are a mixture of stearic acid which is the main component with palmitic acid, myristic acid, lauric acid, arachidic acid and behenic acid. Such commercially available product can also be used as zinc stearate in the second invention.

As explained in the first invention, in view of preventing the mold staining, the amount of a fatty acid sodium salt contained in the fatty acid metal salt (preferably zinc stearate) used in the second invention is preferably not more than 0.1 wt %, more preferably not more than 0.08 wt %, and particularly preferably not more than 0.05 wt %. In particular, fatty acid metal salt (preferably zinc stearate) produced by a direct method is preferable.

The amount to be used of fatty acid metal salt (preferably zinc stearate) is preferably 0.2 to 0.5 parts by weight, more preferably 0.25 to 0.45 part by weight, particularly preferably 0.3 to 0.4 part by weight based on 100 parts by weight of the expandable styrene resin particles (herein meaning expandable styrene resin particles before coating treatment). When the amount to be used of the fatty acid metal salt (preferably zinc stearate) is below the above-mentioned range, the effect of preventing permeation of the contents in the food container including oil and fat tends to decrease. On the other hand, when the amount exceeds the above-mentioned range, there is a tendency that the fusion of particles in the molding process becomes poor and the strength is decreased.

The particle size of the fatty acid metal salt used in the second invention typically represented by zinc stearate is not particularly limited. Usually, from the viewpoint of ease of coating treatment, zinc stearate having an average particle size of 8 to 15 μm, preferably 10 to 13 μm is used. Needless to say, one having a larger or smaller particle size can exhibit the desired effect.

By mixing fatty acid amide and/or fatty acid bisamide and fatty acid metal salt together or individually with expandable styrene resin particles in a mixer such as a Henschel mixer for a pre-determined time, the fatty acid amide and/or fatty acid bisamide and the fatty acid metal salt can be coated on the surface of the expandable styrene resin particles. Coating of the fatty acid amide and/or fatty acid bisamide and the fatty acid metal salt may be conducted by adding a mixture of both or by adding both at the same time to the mixer, but it is preferable for fatty acid metal salt to be coated after coating of fatty acid amide and/or fatty acid bisamide. In the second invention, too, coating refers to the state where fatty acid amide and/or fatty acid bisamide and fatty acid metal salt are present on the surface of the expandable styrene resin particles in some way by coating or attaching.

In the second invention, one or more kinds of glycerin, polyethylene glycol, polypropylene glycol and fatty acid monoglyceride, polyoxyethylene alkyl ether and polyoxyethylene fatty acid ester which are generally used as an antistatic agent may also be used together. Of these, it is preferable to use polyethylene glycol.

The method of producing pre-expanded particles from the expandable styrene resin particles of the second invention and the method of producing molded foam by molding the pre-expanded particles are the same as those in the first invention.

The molded foam obtained by pre-expansion and then molding the expandable styrene resin particles of the second invention can substantially prevent permeation of contents having high permeability such as oil and fat, and therefore can be suitably used as food containers for instant noodles, instant noodles with curry roux, curry roux, curry, stew, mayonnaise, margarine, doughnuts, hamburgers, fried chicken and coffee. In particular, when used as a food container for instant noodles with curry roux, curry roux and curry which contain a great amount of oil and fat and have a considerably high permeability, there is no possibility that the content is permeated through the container wall to the exterior even if stored or transported under severe conditions such as high temperature.

### BEST MODE FOR CARRYING OUT THE INVENTION

In the following, the present invention is described in more detail by means of Examples, but the present invention is not limited to these.

### EXAMPLES A1 TO A8 AND A15, COMPARATIVE EXAMPLES A1 TO A4

A 5-liter reactor equipped with a stirrer was charged with 1.5 liter of pure water, 9.7 g of tricalcium phosphate, 15 ml of 1 wt % sodium α-olefinsulfonate aqueous solution, 1.7 g of sodium chloride and 427 g of styrene resin seed particles having a particle size of 0.2 to 0.3 mm. The temperature of the dispersion in the reactor was raised to 90° C. under stirring. Then, a solution in which 3.6 g of benzoyl peroxide and 3.0 g of 1,1-bis(t-butylperoxy)-3,3,5-trimethyl cyclohexane are dissolved in 1280 g of styrene monomers was charged to the reactor over 5 hours to conduct polymerization. After the completion of charging of the monomer solution, the temperature was immediately raised to 120° C. and post-polymerization was conducted for 3 hours. Thereafter, the highly volatile blowing agent shown in Table 1 was charged to the system and the system was kept at 120° C. for further 3 hours and cooled. The suspension was retrieved and subjected to dehydration, drying and sifting and expandable styrene resin particles having a particle size of 0.3 to 0.5 mm and a weight average molecular weight of 300,000 were obtained.

1000 g of the obtained expandable styrene resin particles (100 parts by weight) was put in a Henschel mixer and with stirring, 0.1 part by weight of polyethylene glycol (molecular weight 400) and 0.35 part by weight of zinc stearate produced by a direct method (available from NOF Corporation, Zinc Stearate GF-200, 60% of the particles having a particle size of not more than 10 μm, average particle size 10 μm) were added sequentially, and expandable styrene resin particles coated by these were obtained.

The obtained expandable styrene resin particles were fed into a rotational stirring pre-expander and foaming was conducted for about 6 minutes in atmosphere of vapor at about 95° C. to a bulk density of 98 g/L to obtain pre-expanded particles. The obtained pre-expanded particles were aged and dried at room temperature for about 20 hours, and then filled into a cup-shaped mold having an internal volume of 500 ml and a wall thickness of 2 mm, heated with vapor of 2.4 kgf/cm² for 5 seconds, and cooled to remove a cup-shaped molded foam from the mold.

The obtained expandable styrene resin particles and the cup-shaped molded foam were subjected to the following evaluation.

(1) Content of Blowing Agent

About 2 g of the expandable styrene resin particles before coating was weighed precisely in an aluminum container and heated at 150° C. for 30 minutes, cooled at room temperature for 30 minutes and weighed again. The content of blowing agent was calculated by using the following formula (5).

content of blowing agent (wt %)={[weight of resin particles (g) before heating−weight of resin particles (g) after heating]/weight of resin particles (g) before heating}×100 (5)

(2) Remaining Amount of Styrene Monomer

The expandable styrene resin particles before coating was dissolved in methylene chloride and the amount of styrene monomer was determined using gas chromatography GC-14B made by Shimadzu Corporation (column filler: polyethylene glycol, column temperature: 110° C., carrier gas: helium) according to an internal standard method (internal standard: cyclopentanol) and the remaining amount of styrene monomer (ppm) contained in the expandable styrene resin particles before coating was calculated.

(3) Fusion Ratio

The side wall of the cup-shaped molded foam was broken by hand and the proportion of expanded particles broken themselves out of all the particles present on the broken section was indicated on percentage. The ratio of not less than 80% is determined to be “good”.

(4) Gap Between Particles on the Surface

The cup-shaped molded foam having little gap between particles on the surface was represented by E, one having little partial color loss after printing which was practically of no problem was represented by G, and one having partial color loss after printing and which was not usable was represented by B.

(5) Permeation Test for Surfactant Solution

About 400 g of an aqueous surfactant solution containing 0.1 wt % of Scourol® 700 conc available from Hokko Chemical Co., Ltd. (ethylene oxide added polyethylene) and 0.005 wt % of eriochrome black T (available from Wako Pure Chemical Industries, Ltd., 2-hydroxy-1-(1-hydroxy-2-naphthylazo)-6-nitro-4-sodium naphthalenesulfonate) was put in the cup-shaped molded foam, and the time to the point where the aqueous surfactant solution was permeated through the outer wall of the cup and droplets begun to emerge was measured. The time of not less than 30 minutes is determined to be “good”.

The result of evaluation is shown in Table 1.

In addition, about 300 kg of coated expandable styrene resin particles produced by increasing the scale of the above-described method were subjected to pre-expansion according to the above-described method, and cup-shaped molded foams were molded continuously for about a week using a mold, and the contamination degree of the mold surface was evaluated. The evaluation criteria are as follows.
E: no change on the mold surface at all
G: the mold surface slightly became black
P: half of the mold surface turned black
B: the entire mold surface turned black

The contamination degree of the mold is shown in Table 1.

### EXAMPLES A9 AND A10, COMPARATIVE EXAMPLES A5 AND A6

Cup-shaped molded foams were obtained in the same manner as in Example A2 except that the amount to be used of zinc stearate was changed as shown in Table 1. The evaluation results are shown in Table 1. Further, molding was conducted continuously for about a week and the contamination degree of the mold surface was evaluated in the same manner as in Example A2. The results are shown in Table 1.

### EXAMPLES A11 AND A12

Cup-shaped molded foams were obtained in the same manner as in Example A1 except that zinc stearate was changed from the product produced by a direct method (available from NOF Corporation: Zinc Stearate GF-200) to a product produced by a double decomposition method having a fatty acid sodium salt content shown in Table 1 (available from NOF Corporation: zinc stearate, 66% of the particles having a particle size of not more than 10 μm, average particle size 7 μm). The evaluation results are shown in Table 1. Further, molding was conducted continuously for about a week and the contamination degree of the mold surface was evaluated in the same manner as in Example A1. The results are shown in Table 1.

The content of a fatty acid sodium salt of zinc stearate was measured by the following method.

Method of Determination of a Fatty Acid Sodium Salt

A small amount of ethanol was added to zinc stearate precisely weighed and impregnated sufficiently, and this was dispersed in water, shaken and then filtrated to remove the insoluble portion. The thus obtained sodium ions in the filtrate were determined by ICP emission spectrochemical analysis and the a fatty acid sodium salt content was calculated.

### EXAMPLE A13

A cup-shaped molded foam was obtained in the same manner as in Example A1 except that the post-polymerization at 120° C. was shortened to 1 hour. The evaluation results are shown in Table 1. Further, molding was conducted continuously for about a week and the contamination degree of the mold surface was evaluated in the same manner as in Example A1. The results are shown in Table 1.

### EXAMPLE A14

A cup-shaped molded foam was obtained in the same manner as in Example A1 except that the post-polymerization at 120° C. was shortened to 0.5 hour. The evaluation results are shown in Table 1. Further, molding was conducted continuously for about a week and the contamination degree of the mold surface was evaluated in the same manner as in Example A1. The results are shown in Table 1.

TABLE 1

| | | | | | | | | | | Evaluation of cup-shaped | | |
|---|---|---|---|---|---|---|---|---|---|---|---|---|
| Expandable styrene | | | | | | | | | | molded article | | |
| resin particles | | | | | | Zinc stearate | | | | | Gap | |
| Remaining | Content of | Composition of blowing | | | | | Content of | | Degree | | between | Test for |
| styrene | blowing | agent (wt %) | | | | | a fatty acid | | of | | particles | sur- |
| monomer | agent | iso- | n- | n- | pro- | Production | sodium salt | (part by | mold | Fusion | on the | factant |
| (ppm) | (wt %) | pentane | pentane | butane | pane | method | (wt %) | weight) | staining | ratio % | surface | (min) |

Example

| | | | | | | | | | | | | | |
|---|---|---|---|---|---|---|---|---|---|---|---|---|---|
| A1 | 80 | 4.2 | 30 | 70 | 0 | 0 | direct method | 0 | 0.35 | E | 90 | E | 45 |
| A2 | 80 | 4.2 | 42 | 58 | 0 | 0 | direct method | 0 | 0.35 | E | 90 | E | 55 |
| A3 | 80 | 4.0 | 50 | 50 | 0 | 0 | direct method | 0 | 0.35 | E | 90 | G | >60 |
| A4 | 80 | 3.7 | 60 | 40 | 0 | 0 | direct method | 0 | 0.35 | E | 90 | G | >60 |
| A5 | 80 | 4.2 | 36 | 55 | 9 | 0 | direct method | 0 | 0.35 | E | 90 | E | 50 |
| A6 | 80 | 4.2 | 38 | 57 | 0 | 5 | direct method | 0 | 0.35 | E | 90 | E | 50 |
| A7 | 80 | 3.0 | 41 | 59 | 0 | 0 | direct method | 0 | 0.35 | E | 85 | E | 40 |
| A8 | 80 | 5.5 | 41 | 59 | 0 | 0 | direct method | 0 | 0.35 | E | 90 | G | 40 |
| A9 | 80 | 4.2 | 42 | 58 | 0 | 0 | direct method | 0 | 0.5 | E | 85 | E | >60 |
| A10 | 80 | 4.2 | 42 | 58 | 0 | 0 | direct method | 0 | 0.2 | E | 90 | E | 35 |
| A11 | 80 | 4.2 | 30 | 70 | 0 | 0 | double | 0.05 | 0.35 | G | 90 | E | 45 |
| | | | | | | | decomposition | | | | | | |
| | | | | | | | method | | | | | | |
| A12 | 80 | 4.2 | 30 | 70 | 0 | 0 | double | 0.07 | 0.35 | P | 90 | E | 45 |
| | | | | | | | decomposition | | | | | | |
| | | | | | | | method | | | | | | |
| A13 | 420 | 4.2 | 30 | 70 | 0 | 0 | direct method | 0 | 0.35 | E | 90 | E | 45 |
| A14 | 980 | 4.2 | 30 | 70 | 0 | 0 | direct method | 0 | 0.35 | E | 90 | E | 45 |
| A15 | 80 | 4.2 | 20 | 80 | 0 | 0 | direct method | 0 | 0.35 | E | 90 | E | 35 |

Compara-
tive
Example

| | | | | | | | | | | | | | |
|---|---|---|---|---|---|---|---|---|---|---|---|---|---|
| A1 | 80 | 3.7 | 70 | 30 | 0 | 0 | direct method | 0 | 0.35 | E | 90 | B | 60 |
| A2 | 80 | 2.5 | 40 | 60 | 0 | 0 | direct method | 0 | 0.35 | E | 40 | E | 40 |
| A3 | 80 | 5.5 | 10 | 90 | 0 | 0 | direct method | 0 | 0.35 | E | 90 | G | 15 |
| A4 | 80 | 6.0 | 41 | 59 | 0 | 0 | direct method | 0 | 0.35 | E | 90 | B | 40 |
| A5 | 80 | 4.2 | 40 | 60 | 0 | 0 | direct method | 0 | 0.6 | E | 60 | G | >60 |
| A6 | 80 | 4.2 | 41 | 59 | 0 | 0 | direct method | 0 | 0.1 | E | 90 | E | 5 |

The expandable styrene resin particles of the first invention have a constitution in which expandable styrene resin particles containing 3 to 5.5 wt % of an highly volatile blowing agent containing 15 to 60 wt % of isopentane and having a styrene monomer content of not more than 1000 ppm are coated with, based on 100 parts by weight of the resin particles, 0.2 to 0.5 parts by weight of zinc stearate containing not more than 0.1 wt % of a fatty acid sodium salt. By subjecting the particles to pre-expansion and then molding, permeation of the content stored in a molded foam such as a food container to the container wall and through the container wall to the exterior can be prevented extremely effectively. In addition, in the first invention, by using zinc stearate containing not more than 0.1 wt % of a fatty acid sodium salt as zinc stearate, occurrence of mold staining when molding molded foams such as a food container can be prevented, and therefore long-term continuous production can be achieved and the productivity can be remarkably improved.

### EXAMPLES B1 TO B15, COMPARATIVE EXAMPLES B1 TO B3

A 5-liter reactor equipped with a stirrer was charged with 1.5 liter of pure water, 9.7 g of tricalcium phosphate, 0.15 g of sodium α-olefinsulfonate, 1.7 g of sodium chloride and 427 g of styrene resin seed particles having a particle size of 0.2 to 0.3 mm. The temperature of the dispersion in the reactor was raised to 90° C. under stirring. Then, a solution in which 3.6 g of benzoyl peroxide and 3.0 g of 1,1-bis(t-butylperoxy)-3,3,5-trimethyl cyclohexane are dissolved in 1280 g of styrene monomers was charged to the reactor over 5 hours to conduct polymerization. After the completion of charging of the monomer solution, the temperature was immediately raised to 120° C. and post-polymerization was conducted for 3 hours. Thereafter, 77 g of pentane (comprising 40 wt % of isopentane and 60 wt % of n-pentane) was charged to the system and the system was kept at 120° C. for further 3 hours and cooled. The suspension was retrieved and subjected to dehydration and drying and expandable styrene resin particles having a particle size of 0.3 to 0.5 mm, a remaining amount of styrene monomer of 40 ppm, a blowing agent content of 4.3 wt % and a weight average molecular weight of 300,000 were obtained. In addition, to test the degree of the mold staining due to the continuous running for molding, the scale of the above-mentioned 5-liter reactor was increased to a 1500-liter reactor, and identical expandable styrene resin particles were produced according to the same recipe and subjected to continuous molding.

1000 g of the obtained expandable styrene resin particles (100 parts by weight) was put in a Henschel mixer, and with stirring, 0.1 part by weight of polyethylene glycol (molecular weight 400), fatty acid amide and/or fatty acid bisamide and fatty acid metal salt shown in Table 1 were added sequentially and expandable styrene resin particles coated with these additives were obtained. Zinc stearate a shown in Table 2 is a product produced by a direct method (available from NOF Corporation, Zinc Stearate GF-200, 60% of the particles having a particle size of not more than 10 μm, average particle size 10 μm), and zinc stearate b is a product produced by a double decomposition method (available from NOF Corporation: Zinc Stearate, having a fatty acid sodium salt content of 0.05 wt %, 66% of the particles having a particle size of not more than 10 μm, average particle size 7 μm). In addition, magnesium stearate is a product produced by a direct method (available from NOF Corporation; Magnesium Stearate GF-200, 63% of the particles having a particle size of not more than 10 μm, average particle size 7 μm).

The obtained expandable styrene resin particles were fed into a rotational stirring pre-expander and foaming was conducted for about 6 minutes in atmosphere of vapor at about 95° C. to a bulk density of 98 g/L to obtain pre-expanded particles.

The obtained pre-expanded particles were aged and dried at room temperature for about 20 hours, and then filled into a cup-shaped mold having an internal volume of 500 ml and a wall thickness of 2 mm, heated with vapor of 2.6 kgf/cm² for 5 seconds, and cooled to remove a cup-shaped molded foam from the mold.

### EXAMPLES B16 TO B18

Cup-shaped molded foams were obtained in the same manner as in Example B1 except that the composition of the blowing agent was changed as shown in Table 3.

The cup-shaped molded foams obtained in Examples B1 to B18 and Comparative Examples B1 to B3 were subjected to the following evaluation. In addition, the contamination degree of the mold surface was evaluated. The results are shown in Table 2 and Table 3.

(1) Fusion Ratio

Evaluated as in Examples A1 to A15.

(2) Gap Between Particles on the Surface

Evaluated as in Examples A1 to A15

(3) Permeation Test for Surfactant Solution

About 400 g of an aqueous surfactant solution containing 0.1 wt % of Scourol®700 conc available from Hokko Chemical Co., Ltd. and 0.005 wt % of eriochrome black T was put in the cup-shaped molded foam, and the time to the point where the aqueous surfactant solution was permeated through the outer wall of the cup and droplets begun to emerge was measured. The time of not less than 30 minute is determined to be “good”.

(4) Test Using Curry

To prove the effect of preventing permeation of oil and fat component, 200 g of curry roux was put in the cup and the cup was wrapped with Saran Wrap® and placed under atmosphere of 60° C. The time to the leakage of curry was measured. The time of not less than 24 hours is determined to be “good”.

(5) Evaluation of Degree of Mold Staining

Evaluated as in Examples A1 to A15.

TABLE 2

| | | | | Evaluation of cup-shaped | | | | |
|---|---|---|---|---|---|---|---|---|
| | | | | molded article | | | | |
| Fatty acid amide and/or | | | | | Gap | | Test | Degree |
| fatty acid bisamide | | Fatty acid metal salt | | | between | Test for | using | of |
| | Part by | | Part by | Fusion | particles on | surfactant | curry | mold |
| Compound | weight | Compound | weight | ratio (%) | the surface | (min) | (Hr) | staining |

Example

| B1 | ethylene bis stearic acid amide | 0.2 | zinc stearate a | 0.40 | 90< | E | 60< | 40 | E |
|---|---|---|---|---|---|---|---|---|---|
| B2 | ethylene bis stearic acid amide | 0.05 | zinc stearate a | 0.40 | 90< | E | 60< | 25 | E |
| B3 | ethylene bis stearic acid amide | 0.25 | zinc stearate a | 0.40 | 90< | E | 60 | 48 | E |
| B4 | ethylene bis stearic acid amide | 0.3 | zinc stearate a | 0.40 | 90< | E | 55 | 60 | E |
| B5 | ethylene bis stearic acid amide | 0.4 | zinc stearate a | 0.40 | 90 | E | 50 | 72 | E |
| B6 | ethylene bis stearic acid amide | 0.2 | zinc stearate a | 0.45 | 90 | E | 60< | 42 | E |
| B7 | ethylene bis stearic acid amide | 0.2 | zinc stearate a | 0.25 | 90< | E | 35 | 35 | E |
| B8 | ethylene bis stearic acid amide | 0.2 | magnesium stearate | 0.40 | 90 | E | 35 | 28 | E |
| B9 | stearic acid amide | 0.2 | zinc stearate a | 0.40 | 90< | E | 50 | 36 | E |
| B10 | stearic acid amide | 0.4 | zinc stearate a | 0.40 | 90< | G | 35 | 48 | E |
| B11 | ethylene bis stearic acid amide | 0.1 | zinc stearate a | 0.40 | 90< | E | 50 | 35 | E |
| | stearic acid amide | 0.1 | | | | | | | |
| B12 | ethylene bis stearic acid amide | 0.2 | zinc stearate a | 0.40 | 90< | E | 55 | 32 | E |
| B13 | palmitic acid amide | 0.2 | zinc stearate a | 0.40 | 90< | E | 60 | 32 | E |
| B14 | oleic acid amide | 0.2 | zinc stearate a | 0.40 | 90< | E | 45 | 28 | E |
| B15 | ethylene bis stearic acid amide | 0.25 | zinc stearate a | 0.40 | 90< | E | 60 | 48 | G |
| Compara- | | | | | | | | | |
| tive | | | | | | | | | |
| Example | | | | | | | | | |
| B1 | None | — | zinc stearate a | 0.40 | 90< | E | 60< | 3 | E |
| B2 | ethylene bis stearic acid amide | 0.005 | zinc stearate a | 0.40 | 90< | E | 60< | 10 | E |
| B3 | ethylene bis stearic acid amide | 0.55 | zinc stearate a | 0.40 | 70 | G | 30 | 72 | E |

Zinc stearate a: produced by direct method, Zinc stearate b: produced by double decomposition method

TABLE 3

| | | | | | | | | | Evaluation of cup-shaped | | | | |
|---|---|---|---|---|---|---|---|---|---|---|---|---|---|
| | | | | | | | | | molded article | | | | |
| | | | | | Composition of blowing | | | | | Gap | Test for | Test | Degree |
| | Fatty acid bisamide | | Fatty acid metal salt | | agent (wt %) | | | | Fusion | between | sur- | using | of |
| | | Part by | | Part by | iso- | n- | iso- | n- | ratio | particles on | factant | curry | mold |
| Example | Compound | weight | Compound | weight | pentane | pentane | butane | butane | (%) | the surface | (min) | (Hr) | staining |
| B16 | ethylene bis | 0.2 | zinc stearate a | 0.40 | 20 | 80 | 0 | 0 | 90< | E | 45 | 35 | E |
| | stearic acid | | | | | | | | | | | | |
| | amide | | | | | | | | | | | | |
| B17 | ethylene bis | 0.2 | zinc stearate a | 0.40 | 36 | 54 | 3 | 7 | 90< | E | 55 | 40 | E |
| | stearic acid | | | | | | | | | | | | |
| | amide | | | | | | | | | | | | |
| B18 | ethylene bis | 0.2 | zinc stearate a | 0.40 | 18 | 72 | 3 | 7 | 90< | E | 40 | 35 | E |
| | stearic acid | | | | | | | | | | | | |
| | amide | | | | | | | | | | | | |

zinc stearate a: produced by direct method

The expandable styrene resin particles of the second invention have a constitution in which expandable styrene resin particles containing an highly volatile blowing agent and having a styrene monomer content of not more than 1000 ppm are coated with 0.01 to 0.5 parts by weight of at least one kind of fatty acid amide and fatty acid bisamide, and 0.2 to 0.5 parts by weight of fatty acid metal salt based on 100 parts by weight of the resin particles. A molded foam such as a food container obtained by subjecting the expandable styrene resin particles to pre-expansion and molding can prevent extremely effectively the component of the content from permeating to the container wall and through the container wall to the exterior, by using it as containers for instant noodle, curry sauce, stew, mayonnaise, margarine, doughnuts, hamburgers, fried chicken and coffee, and the article is excellent in the strength and the printing property.

1. Expandable styrene resin particles comprising expandable styrene resin particles containing 3 to 5.5 wt % of a highly volatile blowing agent containing 15 to 60 wt % of isopentane and having a styrene monomer content of not more than 1000 ppm, wherein the expandable styrene resin particles are coated with, based on 100 parts by weight of the resin particles, 0.2 to 0.5 parts by weight of zinc stearate containing not more than 0.1 wt % of a fatty acid sodium salt.

2. The expandable styrene resin particles according to claim 1, wherein the highly volatile blowing agent contains 30 to 60 wt % of isopentane.

3. The expandable styrene resin particles according to claim 1, wherein the highly volatile blowing agent comprises 15 to 60 wt % of isopentane, 85 to 40 wt % of n-pentane and 0 to 20 wt % of butane and/or propane.

4. The expandable styrene resin particles according to claim 1, wherein zinc stearate is produced by a direct method.

5. Pre-expanded particles obtained by subjecting the expandable styrene resin particles according to claim 1, to pre-expansion.

6. A molded foam obtained by subjecting the pre-expanded particles according to claim 5 to expansion molding.

7. The molded foam according to claim 6, wherein the molded foam is a food container.

8. The molded foam according to claim 7, wherein the molded foam is a food container in accordance with the standard for hot water containers prescribed by the Food Sanitation Law in Japan.

9. Expandable styrene resin particles comprising expandable styrene resin particles containing a highly volatile blowing agent and having a styrene monomer content of not more than 1000 ppm, wherein the expandable styrene resin particles are coated with 0.01 to 0.5 parts by weight of at least one selected from the group consisting of fatty acid amides represented by the following formula (1) and fatty acid bisamides represented by the following formula (2), and 0.2 to 0.5 parts by weight of a fatty acid metal salt based on 100 parts by weight of the resin particles: 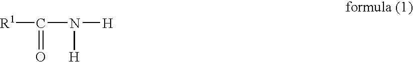
wherein R¹ is a saturated or unsaturated aliphatic hydrocarbon group; and 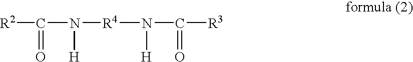
wherein R² and R³ are a saturated or unsaturated aliphatic hydrocarbon group and R⁴ is a divalent aliphatic hydrocarbon group or aromatic hydrocarbon group, provided that R² and R³ may be the same or different.

10. The expandable styrene resin particles according to claim 9, wherein the aliphatic hydrocarbon groups R¹, R² and R³ in the formulas (1) and (2) have 7 to 23 carbon atoms.

11. The expandable styrene resin particles according to claim 10, wherein the aliphatic hydrocarbon groups R¹, R² and R³ in the formulas (1) and (2) have 17 carbon atoms.

12. The expandable styrene resin particles according to claim 9, wherein the hydrocarbon group R⁴ in the formula (2) has 1 to 8 carbon atoms.

13. The expandable styrene resin particles according to claim 9, wherein at least one kind of fatty acid amide represented by the formula (1) and fatty acid bisamide represented by the following formula (2) is stearic acid amide and/or ethylene bis stearic acid amide.

14. The expandable styrene resin particles according to claim 9, wherein at least one kind of fatty acid amide represented by the formula (1) and fatty acid bisamide represented by the following formula (2) is ethylene bis stearic acid amide.

15. The expandable styrene resin particles according to claim 9, wherein the fatty acid metal salt is produced by a direct method.

16. The expandable styrene resin particles according to claim 9, wherein the fatty acid metal salt is zinc stearate.

17. The expandable styrene resin particles according to claim 9, wherein the content of the highly volatile blowing agent is 3 to 6 wt %.

18. The expandable styrene resin particles according to claim 9, wherein the highly volatile blowing agent contains 15 to 60 wt % of isopentane.

19. The expandable styrene resin particles according to claim 9, wherein the highly volatile blowing agent comprises 15 to 60 wt % of isopentane, 85 to 40 wt % of n-pentane and 0 to 20 wt % of butane and/or propane.

20. The expandable styrene resin particles according to claim 9, which have a particle size of 0.2 to 0.6 mm.

21. Pre-expanded particles obtained by subjecting the expandable styrene resin particles according to claim 9 to pre-expansion.

22. A molded foam obtained by subjecting the pre-expanded particles according to claim 21 to expansion molding.

23. The molded foam according to claim 22, wherein the molded foam is a food container.

24. The molded foam according to claim 23, wherein the molded foam is a food container in accordance with the standard for hot water containers prescribed by the Food Sanitation Law in Japan.
